(19) United States
(12) Patent Application Publication
(10) Pub. No.: US 2018/0160863 A1
(43) Pub. Date: Jun. 14, 2018

(54) AUTOMATIC SYNCHRONOUS SOAP DISPENSING AND PAPER TOWEL SUPPLY DEVICE

(71) Applicant: Vida International Inc., Taipei (TW)

(72) Inventors: Zhi-Kai XU, Ontario, CA (US); Bing-Xin ZHU, Taipei Hsien (TW)

(21) Appl. No.: 15/834,577

(22) Filed: Dec. 7, 2017

(30) Foreign Application Priority Data
Dec. 9, 2016 (TW) 105218795

(51) Int. Cl. A47K 5/12; A47K 10/38; G08C 17/02

(52) U.S. Cl. CPC A47K 5/1217; A47K 10/3836; G01J 5/0025; G08C 17/02; A47K 2010/389; A47K 5/1202

(57) ABSTRACT

An automatic synchronous soap dispensing and paper towel supply device comprises a soap dispensing device and a paper towel supply device. The soap dispensing device comprises a soap storage means, a first sensing unit, a first wireless transmission unit and a first control unit, which are used to sense a user's hand that is close to the device, and then automatically dispense soap for hand washing; an at the same time, a wireless signal is sent to the paper towel supply device; the paper towel supply device comprises a paper towel storage means, a second sensing unit, a second wireless transmitting unit and a second control unit, which can function alone to sense a user's hand that is close to the device, and then automatically release paper towel; in addition, the paper towel supply device can receive the wireless signal sent by the soap dispensing device, such that when a user receives the soap, the paper towel can be automatically released for the user to use after hand washing, so as to achieve the object of synchronous soap dispensing and paper towel supply.

### FIELD OF THE INVENTION

The present utility model relates to an automatic synchronous soap dispensing and paper towel supply device; more specifically to an automatic synchronous soap dispensing and paper towel supply device that is used in a rest room and can automatically inform the paper towel supply device in a wireless way to release paper towel while dispensing soap.

### BACKGROUND

Today soap dispensing device and paper towel supply device are available in rest rooms in most public places, such as department stores, hotels, restaurants, hospitals, train and bus stations, which allow users to get soap to thoroughly clean their hands, and get paper towel to dry hands after hand washing. Regarding conventional soap dispensing device and paper towel supply device, they function through manually pressing or automatically sensing. However, due to the health concerns associated with the manually operated devices, which need every user to press the button, the automatically sensing devices currently become the mainstream products; and this is particularly true in locations that need strict control on bacterial and viral contamination, for example hospitals.

However, the automatically sensing soap dispensing device and paper towel supply device are the technical applications that function separately. For example, for a soap dispensing device provided with a sensor, when a user's hand moves close to the sensor, the device will automatically dispense a certain amount of soap; in another example, for a paper towel supply device provided with a sensor, when a user's hand moves close to the sensor, the device will automatically release a piece of paper towel for the use. In light of the foregoing, it can be known that the conventional soap dispensing device and paper towel supply device with automatically sensing need users to repeat the sensing action, rather than provide soap and paper towel for a single sensing action. Accordingly, it can be seen that these devices are not user-friendly and not “smart”.

Moreover, the conventional soap dispensing device and paper towel supply device are installed in a rest room separately, and the soap or paper towel may run out at any time. As a result, the cleaning staff needs to provide repeated monitoring and supply. In the case when the rest rooms are located on different floors and in different buildings (for example, in a large hospital), more staff is needed for such monitoring and supply work. Hence, the conventional soap dispensing device and paper towel supply device need some improvements to address the foregoing issue as well.

### SUMMARY OF THE INVENTION

The object of the present utility model is to provide an automatic synchronous soap dispensing and paper towel supply device, which is able, by way of wireless transmission and control technology, to connect the soap dispensing device and paper towel supply device within the same restroom in a wireless way, so as to achieve the aims of reducing the number of sensing actions, automatically supplying paper towel for drying hands, and remotely monitoring the remaining amount of supply in the devices.

In order to achieve the foregoing aims, the present utility model provides an automatic synchronous soap dispensing and paper towel supply device. One of its preferred technical solutions is as follows: the automatic synchronous soap dispensing and paper towel supply device comprises a soap dispensing device and a paper towel supply device, wherein the soap dispensing device supplies soap for hand washing, the paper towel supply device supplies paper towel for hand drying, characterized in that the soap dispensing device comprises a soap storage means, a first sensing unit, a first wireless transmission unit and a first control unit, wherein the first control unit is electrically connected to the soap storage means, the first sensing unit and the first wireless transmission unit; the first sensing unit is used for proximity sensing and then generating a sensing signal that is transmitted to the first control unit, the first control unit generates a control signal that is transmitted to the soap storage means to enable the soap storage means to dispense a certain amount of soap, and the first control unit also synchronously generates another control signal that is transmitted to the first wireless transmission unit to enable the first wireless transmission unit to send out a wireless signal; the paper towel supply device comprises a paper towel storage means, a second sensing unit, a second wireless transmitting unit and a second control unit, wherein the second control unit is electrically connected to the paper towel storage means, the second sensing unit, and the second wireless transmitting unit; the second sensing unit is used for proximity sensing and then generating a sensing signal that is transmitted to the second control unit, the second wireless transmitting unit receives the wireless signal transmitted by the first wireless transmitting unit and then sending the wireless signal to the second control unit, the second control unit receives the wireless signal from the second sensing unit or the wireless signal from the second wireless transmitting unit, and then generates a control signal that that is transmitted to the paper towel storage means, so as to enable the paper towel storage means to release at least one piece of paper towel.

In the automatic synchronous soap dispensing and paper towel supply device mentioned above, the first sensing unit and the second sensing unit each is an infrared proximity sensor.

In the automatic synchronous soap dispensing and paper towel supply device mentioned above, the first wireless transmitting unit and the second wireless transmitting unit each is a radio frequency unit.

The automatic synchronous soap dispensing and paper towel supply device mentioned above further comprises a remote monitoring means, wherein the first wireless transmitting unit and the second wireless transmitting unit each sends a wireless signal to the remote monitoring means, and the remote monitoring means is used for monitoring the usage counts of the soap dispensing device and the paper towel supply device.

In the automatic synchronous soap dispensing and paper towel supply device mentioned above, the remote monitoring means is a portable electronic device, a computer or a remote monitoring station.

The automatic synchronous soap dispensing and paper towel supply device mentioned above further comprises a wireless relay means, wherein the wireless relay means extends the wireless signals of the first wireless transmitting unit and the second wireless transmitting unit.

When in use, the automatic synchronous soap dispensing and paper towel supply device of the present utility model is able to automatically sense a user's hand when it moves close to the soap dispensing device, and then dispenses the soap, and at the same time, it will send a wireless signal to the paper towel supply device to enable the paper towel supply device to release a piece of paper towel for the user to dry hands. In this way, the user does not need to move hand close to the paper towel supply device for another sensing in order to get paper towel for drying hands. Hence, the device of the present can reduce the number of sensing and is user-friendly and smart. In another case, if a user washes hands without using the soap, the user can still get the paper towel via moving hand close to the paper towel supply device, which enables the paper towel supply device to release the paper towel. On the other hand, through a remote monitoring means, the present invention enables wireless monitoring the soap dispensing device and paper towel supply device in a number of rest rooms, so as to record the usage count of the soap dispensing device and paper towel supply device and calculate the remaining amounts thereof. In this way, the soap and paper towel of the devices can be added in a timely manner.

### BRIEF DESCRIPTION OF THE DRAWINGS

FIG. 1 is a schematic view of the application of the automatic synchronous soap dispensing and paper towel supply device of the present utility model.

FIG. 2 is a schematic view of the application of the remote monitoring means and the wireless relay means of the present utility model.

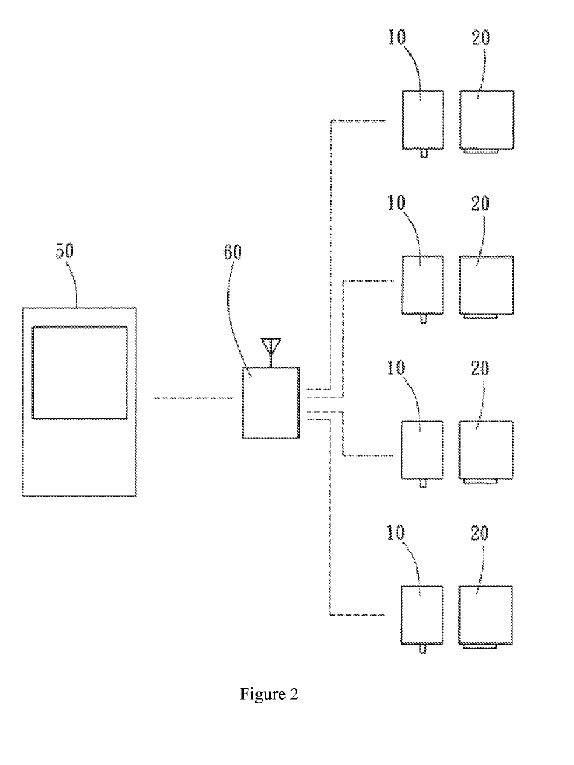

### DETAILED DESCRIPTION

The structural features and other functions and objects of the present utility model will be further described in detail in reference to the accompanying drawings.

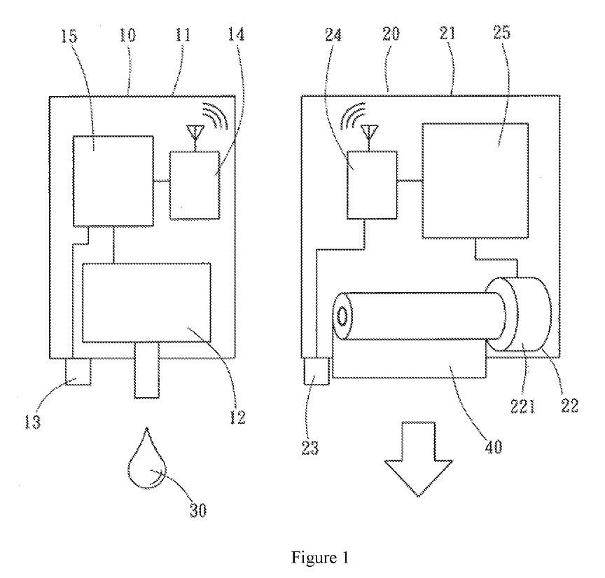

In reference to FIG. 1, the present utility model provides an automatic synchronous soap dispensing and paper towel supply device. A preferred embodiment comprises a soap dispensing device 10 and a paper towel supply device 20, wherein the soap dispensing device 10 is used for automatically sensing and then supplying soap 30 for hand washing, the paper towel supply device is used for automatically sensing and then supplying paper towel 40 for hand drying.

A preferred embodiment of the soap dispensing device 10 comprises a housing 11, wherein there is no limitation on the shape of the housing 11, a soap storage means 12 arranged in the housing 11, wherein the soap storage means 12 is used for storing and dispensing a certain amount of the soap 30, a first sensing unit 13 arranged below or in front of the housing 11, wherein the first sensing unit 13 is an infrared proximity sensor, a first wireless transmission unit 14 arranged in the housing 11, wherein the first wireless transmission unit 14 can be a radio frequency unit, and a first control unit 15 arranged in the housing 11, wherein the first control unit 15 is electrically connected to the soap storage means 12, the first sensing unit 13 and the first wireless transmission unit 14; in this way, the first sensing unit 13 is used for proximity sensing and then generating a sensing signal that is transmitted to the first control unit 15, the first control unit 15 generates a control signal that is transmitted to the soap storage means 12 to enable the soap storage means 12 to dispense a certain amount of soap 30, and the first control unit 15 also synchronously generates another control signal that is transmitted to the first wireless transmission unit 14 to enable the first wireless transmission unit 14 to send out a wireless signal to the paper towel supply device 20.

A preferred embodiment of the paper towel supply device 20 comprises a housing 21, wherein there is no limitation on the shape of the housing 21, a paper towel storage means 22 arranged in the housing 21, wherein the paper towel storage means 22 can hold a roll of paper towel 40, and a motor 221 is further provided for rotating the roll to release the paper towel 40 under the housing 21, a second sensing unit 23 arranged below or in front of the housing 21, wherein the second sensing unit 23 is an infrared proximity sensor, a second wireless transmitting unit 24, wherein the second wireless transmitting unit 24 can be a radio frequency unit, and a second control unit 25, wherein the second control unit 25 is electrically connected to the paper towel storage means 22, the second sensing unit 23, and the second wireless transmitting unit 24; in this way, the second sensing unit 23 is used for proximity sensing and then generating a sensing signal that is transmitted to the second control unit 25, the second wireless transmitting unit 25 receives the sensing signal from the second sensing unit 23, and then generates a control signal that is sent to the paper towel storage means 22, which enables the paper towel storage means 22 to release at least one piece of paper towel 40; in addition, the second wireless transmitting unit 24 may also receive a wireless signal sent from the first wireless transmitting unit 14, and then send the wireless signal to the second control unit 25, the second control unit 25 receives the wireless signal from the second sensing unit 24, and similarly generates a control signal that that is transmitted to the paper towel storage means 22, so as to enable the paper towel storage means 22 to release at least one piece of paper towel 40.

The automatic synchronous soap dispensing and paper towel supply device of the present utility model, by virtue of the wireless connection technology between the soap dispensing device 10 and the paper towel supply device 20, is able to automatically sense a user's hand when it moves close to the first sensing unit 13 of the soap dispensing device 10, and then dispenses the soap 30 via the soap storage means 12, and at the same time, soap dispensing device 10 sends a wireless signal to the paper towel supply device 20 to enable the paper towel storage means 22 of the paper towel supply device 20 to release a piece of paper towel 40 for the user to dry hands by the piece of paper towel 40. In this way, the user does not need to move hand close to the paper towel supply device 20 for another sensing in order to get the paper towel 40 for drying hands. Hence, the device of the present can reduce the number of sensing and is user-friendly and smart. In another case, if a user washes hands simply using water without using the soap dispensing device 10, the user can still get the paper towel 40 via using the paper towel supply device 20 alone, which also enables the paper towel supply device to sense and then release the paper towel 40.

One preferred embodiment of the present utility model may further comprise a remote monitoring means 50 and a wireless relay means 60. The remote monitoring means 50 can be a portable electronic device (such as a mobile phone, a tablet computer or a PDA), a computer or a remote monitoring station. The remote monitoring means 50 can be used for receiving the wireless signals sent from the soap dispensing device 10 and paper towel supply device 20. When in use, the first wireless transmitting unit 14 of the soap dispensing device 10 and the second wireless transmitting unit 24 of the paper towel supply device 20 each can send a wireless signal to the remote monitoring means 50, such that the use information of the soap dispensing device 10 and paper towel supply device 20 is sent to the remote monitoring means 50, or the information of almost running out of supply of the soap dispensing device 10 or paper towel supply device 20 can be sent to the remote monitoring means 50. In this way, the remote monitoring means 50 can monitoring the use condition of the soap dispensing device 10 and paper towel supply device 20, such that the staff can be informed to add supply in a timely manner. Moreover, since many large public places have a number of rest rooms and each rest room is provided with the soap dispensing device 10 and paper towel supply device 20, their wireless signals may not be strong enough to be received. Accordingly, the present utility model further employs a wireless relay means 30 to extend the wireless signals from the first wireless transmitting unit 14 and the second wireless transmitting unit 24, so as to achieve the aim of using a single remote monitoring means 50 to monitor a plurality of soap dispensing devices 10 and paper towel supply devices 20 at the same time.

In summary, the automatic synchronous soap dispensing and paper towel supply device of the present utility model possesses utility and inventiveness, and the technical means employed are also novel. In addition, the function and effect thereof are in line with the objects of the present utility model. Therefore, an application for utility model patent is filed to the Patent Office for examination.

What is claimed is:

1. An automatic synchronous soap dispensing and paper towel supply device, comprising a soap dispensing device and a paper towel supply device, wherein the soap dispensing device supplies soap for hand washing, and the paper towel supply device supplies paper towel for hand drying, and wherein:
the soap dispensing device comprises: a soap storage means; a first sensing unit; a first wireless transmission unit; and a first control unit, wherein the first control unit is electrically connected to the soap storage means, the first sensing unit and the first wireless transmission unit, the first sensing unit is used for proximity sensing and then generating a sensing signal that is transmitted to the first control unit, the first control unit generates a control signal that is transmitted to the soap storage means to enable the soap storage means to dispense a certain amount of soap, and the first control unit also synchronously generates another control signal that is transmitted to the first wireless transmission unit to enable the first wireless transmission unit to send out a wireless signal; and
the paper towel supply device comprises: a paper towel storage means; a second sensing unit; a second wireless transmitting unit; and a second control unit, wherein the second control unit is electrically connected to the paper towel storage means, the second sensing unit, and the second wireless transmitting unit, the second sensing unit is used for proximity sensing and then generating a sensing signal that is transmitted to the second control unit, the second wireless transmitting unit receives the wireless signal transmitted by the first wireless transmitting unit and then sending the wireless signal to the second control unit, the second control unit receives the wireless signal from the second sensing unit or the wireless signal from the second wireless transmitting unit, and then generates a control signal that that is transmitted to the paper towel storage means, so as to enable the paper towel storage means to release at least one piece of paper towel.

2. The automatic synchronous soap dispensing and paper towel supply device according to claim 1, wherein the first sensing unit and the second sensing unit each is an infrared proximity sensor.

3. The automatic synchronous soap dispensing and paper towel supply device according to claim 1, wherein the first wireless transmitting unit and the second wireless transmitting unit each is a radio frequency unit.

4. The automatic synchronous soap dispensing and paper towel supply device according to claim 1, further comprising a remote monitoring means, wherein the first wireless transmitting unit and the second wireless transmitting unit each sends a wireless signal to the remote monitoring means, and the remote monitoring means is used for monitoring the usage counts of the soap dispensing device and the paper towel supply device.

5. The automatic synchronous soap dispensing and paper towel supply device according to claim 4, wherein the remote monitoring means is a portable electronic device, a computer or a remote monitoring station.

6. The automatic synchronous soap dispensing and paper towel supply device according to claim 1, further comprising a wireless relay means, wherein the wireless relay means extends the wireless signals of the first wireless transmitting unit and the second wireless transmitting unit.
